(19) United States
(12) Patent Application Publication
(10) Pub. No.: US 2025/0334555 A1
(43) Pub. Date: Oct. 30, 2025

(54) Waveform-Analyzing Method and Waveform-Analyzing Device

(71) Applicant: SHIMADZU CORPORATION, Kyoto-shi (JP)

(72) Inventor: Shinji KANAZAWA, Kyoto-shi (JP)

(21) Appl. No.: 19/189,039

(22) Filed: Apr. 24, 2025

(30) Foreign Application Priority Data
Apr. 25, 2024 (JP) 2024-071492

(51) Int. Cl. G01N 30/86; G01N 30/02

(52) U.S. Cl. CPC G01N 30/8675; G01N 30/8631; G01N 30/8662; G01N 2030/027

(57) ABSTRACT

A waveform-analyzing device includes a trained-model storage section (44) for a trained model which detects a peak from a waveform. The model is constructed by machine learning using reference waveform data as teaching data. Each reference waveform has a different baseline shape and a known position of a peak portion including an overlap peak, with tailing processing, complete separation or vertical partitioning related to this peak. For an input of measurement data, the model outputs an index which represents a single-peak, overlap-peak or non-peak portion and to which the tailing processing, complete separation or vertical partitioning is related as a peak separation technique. A n index outputter (55-57) inputs analysis-target data into the model to obtain an output of the index which represents a single-peak, overlap-peak or non-peak portion and to which the tailing processing, complete separation or vertical partitioning is related as the technique for separating the overlap-peak portion.

### TECHNICAL FIELD

The present invention relates to a method and device for analyzing a waveform acquired by a measurement of a sample by means of an analyzer.

### BACKGROUND ART

Liquid chromatographs and gas chromatographs have been used for identifying a component contained in a sample and/or determining its quantity. In a chromatograph, the components contained in a sample are separated from each other by a column, and the components which sequentially exit from the column are detected. A chromatogram with the horizontal axis representing time and the vertical axis representing detection intensity is subsequently created. A peak is detected in the chromatogram and the concentration and/or content of a compound corresponding to that peak is determined from the area or height of the peak.

To date, various methods for detecting a peak in a chromatogram have been in practical use. In recent years, methods which employ machine learning have been proposed and put into practical use as new peak detection methods (for example, see Patent Literature 1 as well as Non Patent Literatures 1 and 2).

Patent Literature 1 describes a waveform-analyzing technique in which a trained model is constructed by machine learning in which a plurality of sets of reference waveform data, with the positions of their respective peak portions previously known, are used as teaching data, and a peak portion included in the data of a waveform to be analyzed is estimated by means of that trained model. In an example described in the document, the trained model is constructed from a learning model which uses the technique of semantic segmentation used in the area of image analysis, by performing machine learning of this model in which data of a plurality of extracted ion chromatograms (EIC) acquired by a selected ion monitoring (SIM) or multiple reaction monitoring (MRM) measurement, with the positions of their respective peak portions previously known, are used as teaching data. In an actual analysis of an extracted ion chromatogram acquired by a SIM or MRM measurement, a specified number of points of measurement data extracted from that chromatogram are fed into the trained model, which outputs an index (label) that shows whether each point of data belongs to a peak portion or non-peak portion. Patent Literature 1 also describes the idea of outputting an index which indicates the most suitable method for separating a plurality of peaks overlapping each other on a chromatogram (“overlap peak”) among three separation methods: tailing processing (in which the overlap peak is separated into one peak ranging from the beginning point to the ending point of the overlap peak and another peak superposed on the tailing portion of the former peak), complete separation (in which peaks are separated by a line connecting the beginning point, local minimum point and ending point of the overlap peak) and vertical partitioning (in which two peaks are separated by a vertical line passing through the local minimum point of the overlap peak).

### CITATION LIST

### Patent Literature

Patent Literature 1: WO 2021/064924 A

### Non Patent Literature

Non Patent Literature 1: “Peakintelligence™ for GCMS—LabSolutions Insight™ Muke Hakei Shori Sofutouea (Peakintelligence™ for GCMS—Peak Processing Software for LabSolutions Insight™)”, [online], [accessed on Mar. 14, 2024], Shimadzu Corporation, the Internet
Non Patent Literature 2: “Peakintelligence™ for LCMS-LabSolutions™ LCMS, LabSolutions Insight™ Muke Hakei Shori O pushon Sofutouea (Peakintelligence™ for LCMS—Peak Processing Optional Software for LabSolutions™ LCMS and LabSolutions Insight™)”, [online], [accessed on March 14, 2024], Shimadzu Corporation, the Internet

1Non Patent Literature 3: Takero Sakai, Shinji Kanazawa, “Peakintelligence™ for GCMS™ Ni Yoru Nouyaku Deeta Kaiseki Jikan No Tanshuku (Time-Saving Effect of Peakintelligence™ for GCMS™ on Pesticide Data Analysis)”, [online], [accessed on Mar. 14, 2024], Shimadzu Corporation, the Internet
Non Patent Literature 4: “Nexera-i MT Ni Yoru Oushuu Yakkyokukata Ni Junkyo Shita Iyakuhin Fujunbutsu Bunseki No Kousokuka (Use of Nexera-i MT for High-Speed Analysis of Impurities in Drug According to European Pharmacopeia)”, [online], [accessed on Mar. 14, 2024], Shimadzu Corporation, the Internet

### SUMMARY OF INVENTION

### Technical Problem

Increasing the accuracy of the determination of the peak portion by the trained model requires a large number of sets of teaching data. In order to prepare such a large number of sets of teaching data, chromatograms acquired under typical measurement conditions or created by a simulation assuming typical measurement conditions are often used as the teaching data.

However, the shape of the chromatogram varies depending on the configuration of the analyzer and the measurement conditions. For example, a narrow, sharp peak is likely to be obtained in the case where a mass analyzer is used as the detector in the chromatograph, while peaks having various widths appear when a PDA detector or UV detector is used (for example, see Non Patent Literatures 3 and 4). Furthermore, when a gradient analysis is performed in a liquid chromatograph, or when a temperature-programmed analysis is performed in a gas chromatograph, a drift of the baseline is likely to occur. When a plurality of peaks overlapping each other (overlap peak) are present on a chromatogram, those peaks need to be separated by one of the conventionally known peak separation techniques including the tailing processing, complete separation and vertical partitioning, and the most suitable technique for separating the peaks depends on the shape of the baseline. Since the shape of the baseline varies depending on the configuration of the analyzer and the measurement conditions, there are cases in which it is difficult to correctly detect peaks by conventional trained models.

Although the description so far has been concerned with the case of detecting a peak from a chromatogram acquired by a chromatograph, there are also similar problems with the case of detecting a peak from other types of waveform data.

The problem to be solved by the present invention is to provide a technique by which a peak can be correctly detected from a chromatogram regardless of the configuration of the device and the measurement conditions.

### Solution to Problem

One mode of the present invention developed for solving the previously described problem is a waveform-analyzing method for analyzing a waveform formed by analysis-target data which is a set of data acquired by a measurement of a sample using an analyzer, the waveform-analyzing method including:
a trained-model construction step for constructing a trained model by machine learning in which a plurality of sets of reference waveform data which are sets of data each of which forms one of a plurality of reference waveforms are used as teaching data, where each of the reference waveforms has a different shape of the baseline, has a known position of a peak portion including an overlap peak, and is related to a technique selected from the group consisting of tailing processing, complete separation and vertical partitioning as a technique for separating the overlap peak, and the trained model is configured to receive an input of measurement data and output an index for each of data elements constituting the measurement data, where the index represents a single-peak portion, an overlap-peak portion or a non-peak portion and is related to a technique selected from the group consisting of tailing processing, complete separation and vertical partitioning as the technique to be used for separating the overlap peak concerned; and
an index output step for inputting the analysis-target data into the trained model and obtaining, from the trained model, an output of the index for each of a plurality of analysis-target-data elements constituting the analysis-target data, where the index represents a single-peak portion, an overlap-peak portion or a non-peak portion and is related to a technique selected from the group consisting of tailing processing, complete separation and vertical partitioning as the technique to be used for separating the overlap peak concerned.

Another mode of the present invention developed for solving the previously described problem is a waveform-analyzing device configured to analyze a waveform formed by analysis-target data which is a set of data acquired by a measurement of a sample using an analyzer, the waveform-analyzing device including:
a trained-model storage section in which a trained model is stored, the trained model constructed by machine learning in which a plurality of sets of reference waveform data which are sets of data each of which forms one of a plurality of reference waveforms are used as teaching data, where each of the reference waveforms has a different shape of the baseline, has a known position of a peak portion including an overlap peak, and is related to a technique selected from the group consisting of tailing processing, complete separation and vertical partitioning as a technique for separating the overlap peak, and the trained model is configured to receive an input of measurement data and output an index for each of data elements constituting the measurement data, where the index represents a single-peak portion, an overlap-peak portion or a non-peak portion and is related to a technique selected from the group consisting of tailing processing, complete separation and vertical partitioning as the technique to be used for separating the overlap peak concerned; and
an index outputter configured to input the analysis-target data into the trained model and obtain, from the trained model, an output of the index for each of a plurality of analysis-target-data elements constituting the analysis-target data, where the index represents a single-peak portion, an overlap-peak portion or a non-peak portion and is related to a technique selected from the group consisting of tailing processing, complete separation and vertical partitioning as the technique to be used for separating the overlap peak concerned.

### Advantageous Effects of Invention

In the present invention, when a trained model is constructed by machine learning, a plurality of sets of reference waveform data are used as teaching data for performing the machine learning, where the plurality of sets of reference waveform data are sets of data each of which forms one of a plurality of reference waveforms, where each of the reference waveforms has a different shape of the baseline, has a known position of a peak portion including an overlap peak which is a plurality of peaks overlapping each other, and is related to a technique selected from the group consisting of tailing processing, complete separation and vertical partitioning as a technique for separating the overlap peak. Therefore, a trained model is constructed which takes into account the shape of the baseline in estimating the peak portion as well as in estimating the peak-separation technique suitable for an overlap peak. According to the present invention, when analysis-target data is fed into the trained model, the model correctly estimates the peak portion by taking into account the shape of the baseline which appears in a specific form depending on the type of detector and the measurement conditions. The model also outputs an index which represents a peak separation technique suitable for separating the overlap peak. Therefore, the peaks can be correctly detected from the chromatogram regardless of the configuration of the device and the measurement conditions.

### BRIEF DESCRIPTION OF DRAWINGS

FIG. 1 is a configuration diagram of the main components of a liquid chromatograph system including one embodiment of the waveform-analyzing device according to the present invention.

FIG. 2 is an example of a chromatogram including a section having a drift of the baseline and a column-washing section.

FIG. 3 shows examples of an overlap peak separated by tailing processing, complete separation and vertical partitioning.

FIG. 4 is an example of an overlap peak which cannot be correctly separated by a conventional technique.

FIG. 5 shows examples of peaks to which the labels (indices) representing “single peak on a tailing portion”, “vertical partitioning peak on a tailing portion”, “peak on a tailing portion” and “peak on a leading portion” are respectively related.

FIG. 6 is a flowchart of the procedure for creating a trained model in one embodiment of the waveform-analyzing method according to the present invention.

FIG. 7 is a diagram illustrating situations in which the first window, second window and third window are respectively applied to teaching data.

FIG. 8 is a flowchart of the procedure for estimating a peak portion included in unanalyzed chromatogram data in one embodiment of the waveform-analyzing method according to the present invention.

FIG. 9 is an example of an analysis of a chromatogram using the waveform-analyzing device and the waveform-analyzing method according to the present embodiment.

### DESCRIPTION OF EMBODIMENTS

An embodiment of the waveform-analyzing method and the waveform-analyzing device according to the present invention is hereinafter described with reference to the drawings.

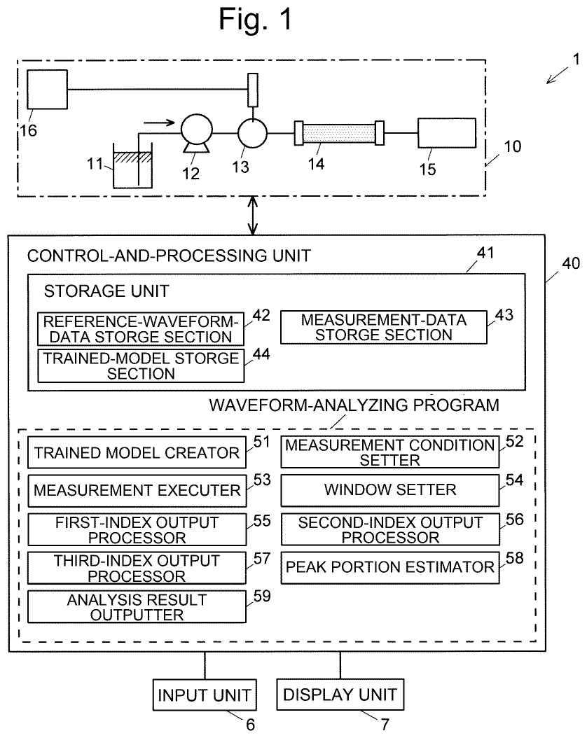

FIG. 1 shows the configuration of the main components of a liquid chromatograph system 1 including the waveform-analyzing device according to the present embodiment. The liquid chromatograph system 1 includes a liquid chromatograph unit 10 and a control-and-processing unit 40. A portion of the control-and-processing unit 40 corresponds to the waveform-analyzing device according to the present invention.

The liquid chromatograph unit 10 includes a mobile phase container 11 in which a mobile phase is contained, a liquid-supply pump 12 for supplying a mobile phase from the mobile phase container 11, an injector 13 for injecting a liquid sample, a column 14 for separating components contained in the liquid sample, and a detector 15 for detecting the components sequentially exiting from the column 14. The unit also includes an autosampler 16 in which sample containers holding a plurality of liquid samples are set, and which is configured to sequentially introduce those liquid samples into the injector 13 in a specific order described in the measurement conditions. As for the detector 15, a suitable type of detector for the components to be detected is used, such as a mass analyzer, ultraviolet absorbance detector (UV detector), photodiode array detector (PDA detector), differential refractive index detector (RID) or electric conductivity detector.

The control-and-processing unit 40 includes a storage unit 41. The storage unit 41 has a reference-waveform-data storage section 42, measurement-data storage section 43, and trained-model storage section 44. The reference-waveform-data storage section 42 holds “reference waveform data”, which are measurement data acquired by measurements using a mass analyzer, ultraviolet absorbance detector (UV detector), photodiode array detector (PDA detector), differential refractive index detector (RID), electric conductivity detector and other types of devices as the detector 15, and on which the peak detection and other kinds of processing have already been performed, along with the related information, such as the measurement conditions (including the sampling rate) and the type of detector.

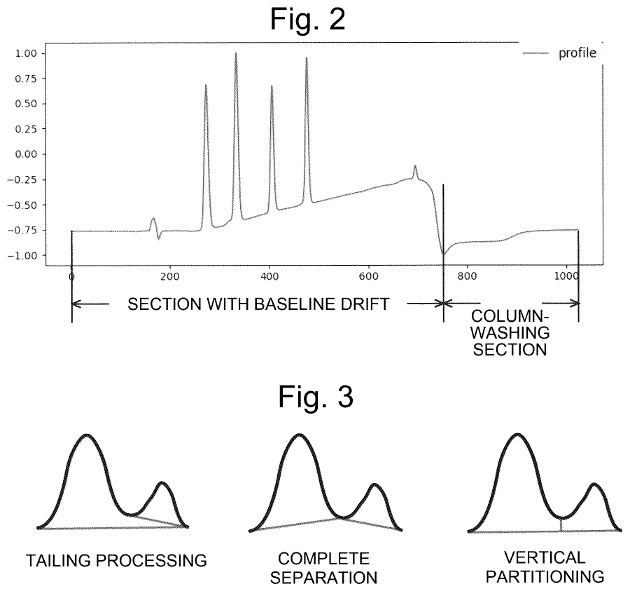

In the case of a liquid chromatograph, the reference waveform data is normally in the form of two-dimensional data with the horizontal axis representing time or sampling interval and the vertical axis representing intensity. However, the reference waveform data may also be prepared in the form of a one-dimensional data sequence in which only the output signals from the detector are arranged in time series, excluding the information of the sampling interval which is previously known. The reference waveform data may have a peak portion already located within the data. Each of the sets of data used as the reference waveform data has a different shape of the baseline, has a known position of a peak portion including an overlap peak, and is related to a label (index) representing a technique selected from the group consisting of tailing processing, complete separation and vertical partitioning as a technique for separating the overlap peak. Specifically, for example, the reference waveform data may include a chromatogram acquired by a gradient analysis, with the baseline increasing (or decreasing) throughout the entire measurement period, and a chromatogram acquired by a continuous measurement of a plurality of samples, with a column-washing period provided in the middle of the continuous measurement. FIG. 2 shows an example of such chromatograms.

The reference waveform data also includes a waveform having an overlap peak consisting of a peak having a leading or tailing portion on which another peak is superposed (an overlap peak to which the tailing processing is related) and/or a waveform having an overlap peak consisting of a plurality of peaks whose base portions overlap each other (an overlap peak to which either the complete separation or the vertical partitioning is related). FIG. 3 shows examples of an overlap peak separated by tailing processing, complete separation and vertical partitioning.

In normal cases, an overlap peak has peak-beginning point A, peak-beginning point B, peak-ending point A and peak-ending point B sequentially located in ascending order of their retention times (from the origin). As a general rule, tailing processing is suited for separating an overlap peak when one half or more of the entire section of the overlap peak is formed by the tailing of one peak, while vertical partitioning is suited when the ending point of one peak (which has a shorter retention time) coincides with the beginning point of the other peak (which has a longer retention time). However, these rules are only applicable in normal chromatograms. In the case of a chromatogram with a fluctuating baseline, determining the technique for separating an overlap peak according to the aforementioned rule-bases does not always result in the selection of an appropriate separation technique. As an example of the rule-bases, a prior application by the present applicant (Japanese Patent Application No. 2023-065939) describes a technique for determining the multimodality of an overlap peak based on the ratio of the intensity (peak height or peak-trough depth) or the peak distance of the neighboring peaks. The technique described in this prior application may possibly be applied to determine the multimodality based on a mutual comparison of the peaks rather than a comparison of the peaks with the noise level. However, in some cases, it is impossible to determine an appropriate separation technique by these rule-based methods.

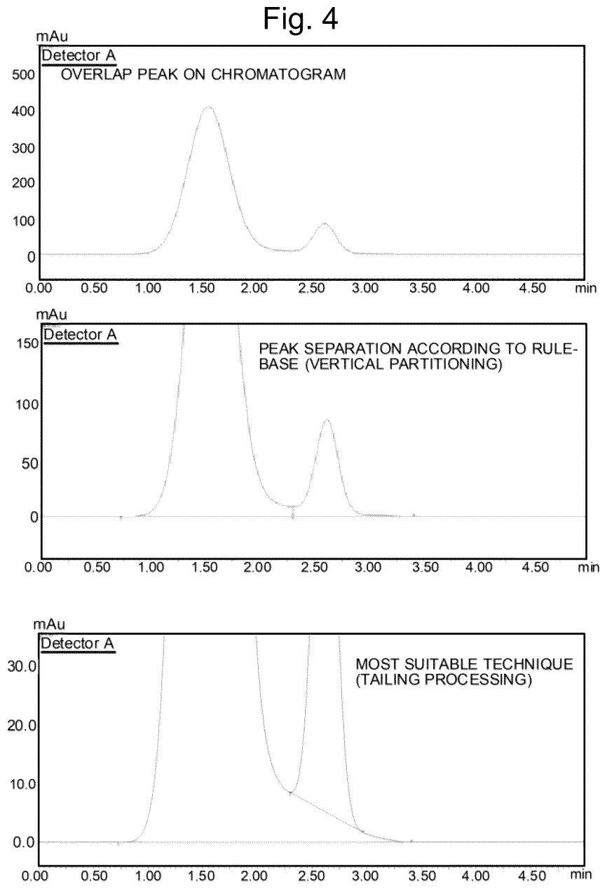

FIG. 4 shows an example of such a chromatogram. The upper section of FIG. 4 shows an overlap peak on a chromatogram. When the conventional technique which determines the separation technique based on the rule-bases in the previously described manner was used, the vertical separation as shown in the middle section was recommended for this overlap peak. However, as shown by the enlarged view in the lower section of FIG. 4, this overlap peak actually consists of a larger peak located at a shorter retention time and a smaller peak emergent on the tailing portion of the larger peak. Therefore, this overlap peak should be separated by tailing processing. The rule-based technique is not satisfactory for correctly separating this type of overlap peak; a trained model constructed by machine learning as in the present embodiment is useful for this purpose.

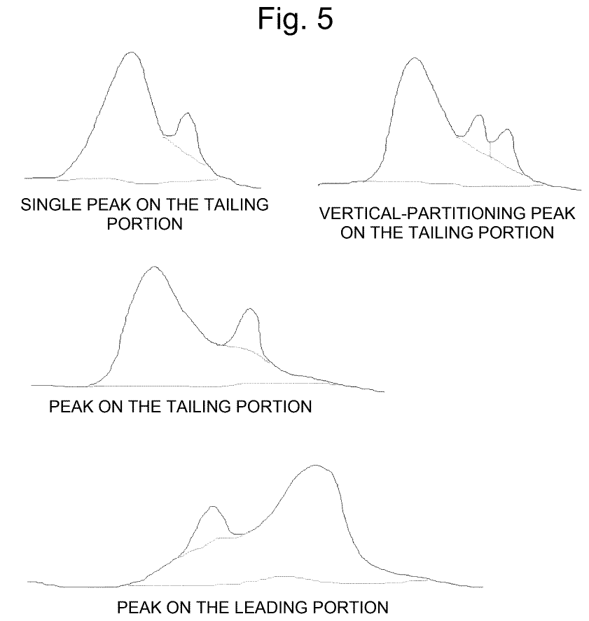

The labels of the tailing processing are realized by being further subdivided into the “single peak on a tailing portion”, “vertical partitioning peak on a tailing portion”, “peak on a tailing portion” and “peak on a leading portion”. FIG. 5 schematically shows examples of the peaks to which the labels (indices) representing “single peak on a tailing portion”, “vertical partitioning peak on a tailing portion”, “peak on a tailing portion” and “peak on a leading portion” are respectively related.

The control-and-processing unit 40 includes, as its functional blocks, a trained model creator 51, measurement condition setter 52, measurement executer 53, window setter 54, first-index output processor 55, second-index output processor 56, third-index output processor 57, peak portion estimator 58 and analysis result outputter 59. The control-and-processing unit 40 is actually a generally used personal computer, on which the aforementioned functional blocks are embodied by executing a pre-installed waveform-analyzing program on the processor of the computer. Additionally, an input unit 6 consisting of a keyboard, mouse and other devices, as well as a display unit 7 consisting of a liquid crystal display and other devices, are connected to the control-and-processing unit 40.

Next, a method for analyzing a chromatogram using the chromatograph mass spectrometry system according to the present embodiment is described. In the chromatograph mass spectrometry system according to the present embodiment, when the waveform-analyzing program is executed, a screen for selecting either the creation of a trained model or the analysis of chromatogram data is shown on the display unit 7.

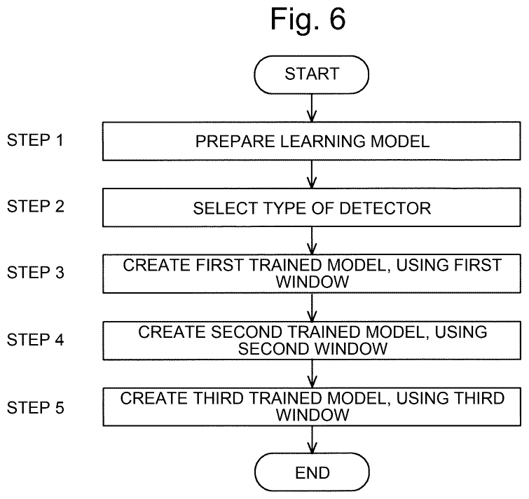

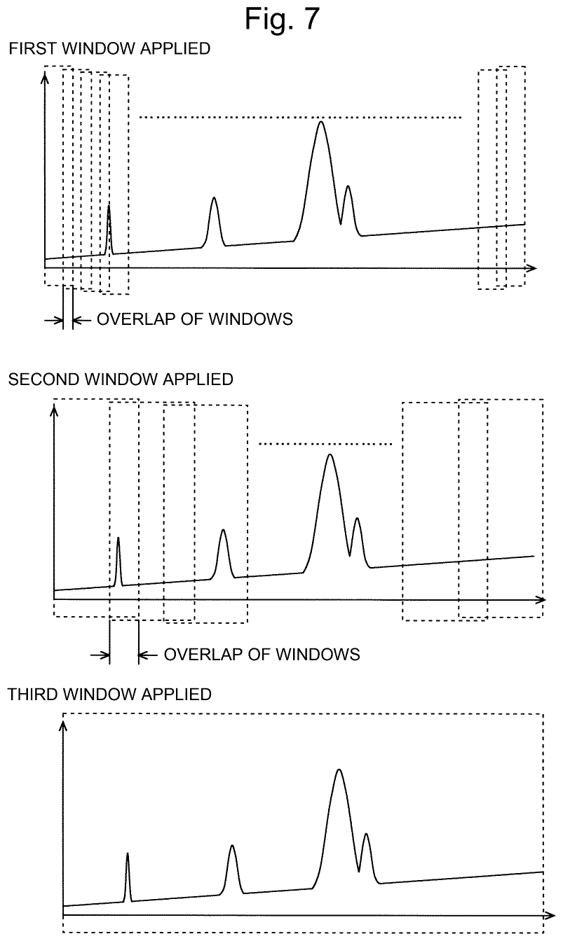

Initially, the procedure for creating a trained model is described with reference to the flowchart in FIG. 6.

When the creation of a trained model is selected by the user, the trained model creator 51 prepares an untrained learning model (Step 1). As for this leaning model, various types of models capable of performing semantic segmentation can be suitably used. Semantic segmentation is generally used for analyzing images consisting of two-dimensionally distributed pixel data. However, in the present embodiment, for example, the technique is applied in an analysis of the waveform data of a chromatogram consisting of a plurality of pieces of data one-dimensionally arranged along the time axis. Examples of the learning models available for performing semantic segmentation include U-Net, SeGNet and PSPNet (for example, see Patent Literature 1). In the present embodiment, U-Net is used as the learning model.

Subsequently, the trained model creator 51 reads reference waveform data from the reference-waveform-data storage section 42. Using the reference waveform data as teaching data for the learning model, machine learning is performed to create a trained model configured to receive an input of measurement data and output a label which represents the properties of each of the data elements constituting the measurement data. For example, the labels in the present embodiment may include “baseline”, “single (isolated peak)”, “complete separation peak”, “vertical partitioning peak”, “peak-beginning point”, “peak-ending point”, “single peak on a tailing portion”, “vertical partitioning peak on a tailing portion” and “column-washing section”. The kinds of labels can be appropriately changed according to the purpose of the analysis to be carried out later; it is possible to use only a subset of those labels, or to add other labels. An example of the label to be added is “no-elution section” (which identifies the period of time until a component having the shortest retention time among the components in the sample exits from the column, i.e., the period of time during which there is no need to detect peaks).

The number of data points that can be fed into the learning model may be set to any appropriate value. However, inputting a large number of data points leads to a long period of time required for the processing. Therefore, in the present embodiment, the number of data points to be fed into the U-Net is set to 1,024.

The trained model creator 51 initially extracts 1,024 points of measurement data elements from the beginning (i.e., from the end with the shortest time; the same applies hereinafter) in the measurement data and feeds those points of data as one set into the U-Net to let this model learn the teaching data by machine learning. The range (frame) to be used for extracting one set of partial measurement data from the measurement data is called the “window”. The first window used here is given a width corresponding to the sampling rate multiplied by 1,024. As schematically shown in the upper section of FIG. 7, the first window is gradually shifted, with the neighboring windows overlapping each other by one third to one half of the width of the first window, so that the machine learning is performed throughout the entire reference waveform data. B y this method, almost all peaks appearing in a chromatogram can be covered by the first windows in such a manner that each peak is included in one window. Although distinguishing between a peak portion and a non-peak portion is possible even when a portion of the peak is located outside the first window, setting the window to include the entire peak can improve the identification accuracy of the peak.

Next, the trained model creator 51 performs machine learning in a similar manner to the previously described case, applying a second window having a width previously related to the type of detector.

As noted earlier, various types of detectors are used for liquid chromatographs depending on the component to be detected, such as a mass analyzer, ultraviolet absorbance detector (UV detector), photodiode array detector (PDA detector), differential refractive index detector (RID) and electric conductivity detector. The shape and width of a peak which appears in a chromatogram vary depending on the detector used. Therefore, it is also useful to determine the width of the second window for each type of detector so that a peak whose peak width is the largest among all possible peaks for that type of detector will be entirely included in one second window.

For example, when the detector is a mass analyzer, the largest possible width of the peak is approximately 1.5 minutes, whereas a peak having a width of five or ten minutes may possibly appear when the detector is a PDA detector or UV detector. Accordingly, the width of the second window is determined beforehand for each type of detector. For example, when the detector is a mass analyzer, the width of the second window is previously set to 3 minutes. For a PDA detector or UV detector, the width of the second window is previously set to 15 minutes. The width of the second window is, for example, 1.5 to 2 times the largest possible width of the peak. When the process of the sliding window is performed, as schematically shown in the middle section of FIG. 7, the window may be shifted so that the neighboring windows overlap each other by one third to one half of the width of the second window.

In the case of using the second window, the number of measurement data elements present within the second window is larger than that of the data elements to be fed into the U-Net. Accordingly, in the case of using the second window, the number of measurement data elements present within the second window may preferably be adjusted to 1,024 by a preparative computation, e.g., by totaling or averaging a plurality of measurement data elements, or thinning the measurement data elements, before the measurement data elements are fed into the U-Net for the machine learning.

Furthermore, the trained model creator 51 may also perform machine learning for all sets of reference waveform data in a similar manner to the previously described case, applying a third window having a width which corresponds to the entire measurement period.

In a liquid chromatograph, a gradient analysis may be performed in which the mixture ratio of a plurality of mobile phases is gradually changed during the measurement. A gradient analysis is accompanied by the so-called “drift”, i.e., a gradual increase (or decrease) of the baseline throughout the entire period of the measurement. A trained model that can correctly discriminate between a drift and a peak cannot be easily obtained by machine learning which uses only a portion of the reference waveform data. Accordingly, in the present embodiment, as schematically shown in the lower section of FIG. 7, the machine learning in which a third window corresponding to the entire period of the measurement is applied is performed. In the case of using the third window, the number of measurement data elements present within the third window is larger than that of the measurement data elements to be fed into the U-Net. Accordingly, in the case of using the third window, as in the previously described case, the number of measurement data elements present within the third window is adjusted to 1,024 by a preparative computation, e.g., by averaging a plurality of measurement data elements or thinning the measurement data elements, before the measurement data elements are fed into the U-Net for the machine learning.

The trained model creator 51 constructs the trained model by performing the previously described processing and stores the same model in the trained-model storage section 44. As noted earlier, the reference waveform data in the present embodiment includes, for example, a chromatogram acquired by a gradient analysis, with the baseline increasing (or decreasing) throughout the entire measurement period, and a chromatogram acquired by a continuous measurement of a plurality of samples, with a column-washing period provided in the middle of the continuous measurement. The reference waveform data also includes a chromatogram having an overlap peak consisting of a peak having a leading or tailing portion on which another peak is superposed (an overlap peak to which the tailing processing is related) and/or a chromatogram having an overlap peak consisting of a plurality of peaks whose base portions overlap each other (an overlap peak to which either the complete separation or the vertical partitioning is related). Therefore, a trained model which can discriminate between various forms of the baseline as well as between various shapes of overlap peaks will be constructed.

As regards the column-washing section, it may be possible to read information concerning the column-washing period from a method file describing the measurement conditions and reflect that period in locating the column-washing section. However, it is not guaranteed that the period during which the column washing is actually performed completely coincides with the washing period specified as a measurement condition; a discrepancy may occur between them. This particularly occurs in the case of a continuous measurement of a large number of samples, in which case the aforementioned discrepancy accumulates in the ending phase of the series of measurements, and consequently, a section of the chromatogram corresponding to the period of time during which a sample component is still exiting from the column may incorrectly identified as a washing section, i.e., a period of time during which no peak detection should be performed, if the column-washing period read from the measurement conditions is treated as a washing section. In contrast, according to the present embodiment, the washing section is estimated based on the chromatogram data, and therefore, the washing section in the chromatogram can be correctly identified even if there is a discrepancy between the column-washing period specified in the measurement conditions and the column-washing period in the actual measurement.

In the present embodiment, three trained models are created in the previously described manner. It is also possible to only construct a single trained model using one of the three aforementioned windows. However, it is preferable to construct a plurality of trained models using windows having different widths as in the present embodiment. Each of the three aforementioned windows is suited for identifying a peak of a different width or a background. The use of the plurality of trained models enables a more correct detection of peaks.

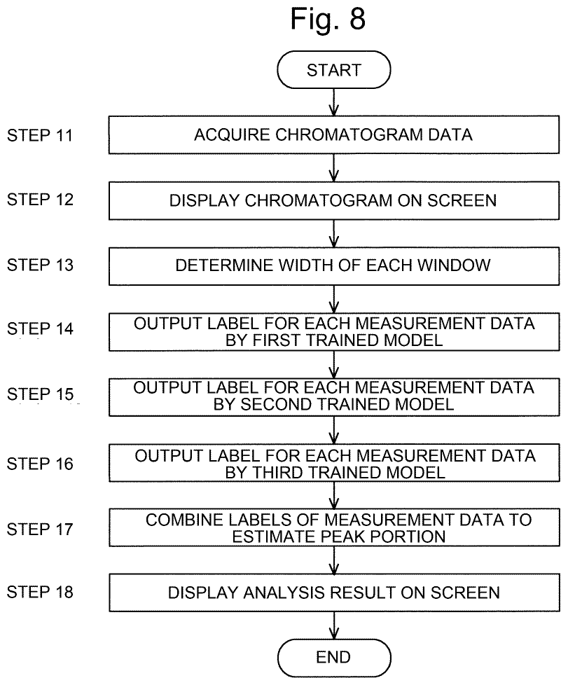

Next, the procedure for analyzing the waveform of an unanalyzed chromatogram is described with reference to the flowchart in FIG. 8. The following description deals with the case in which three trained models which respectively use the three aforementioned windows have been constructed by machine learning. In the following description, a trained model constructed by machine leaning using a window having a width determined based on the sampling rate (“first window”) is called the “first trained model”, a trained model constructed by machine leaning using a window having a width determined according to the type of detector (“second window”) is called the “second trained model”, and a trained model constructed by machine leaning using a window having a width corresponding to the entire measurement range (“third window”) is called the “third trained model”.

A user sets samples in the autosampler 16 and issues a command to initiate the analysis. Then, the measurement condition setter 52 reads the measurement conditions stored in the measurement-data storage section 43 and shows them on the screen of the display unit 7. These measurement conditions include the type of detector to be used for the measurement and the information of the sampling rate of the detector. After selecting the measurement condition to be used from the displayed options (and making appropriate modifications as needed), the user issues a command to initiate the measurement. Then, the measurement condition setter 52 creates a batch file for carrying out the measurement under the selected condition and saves it in the measurement-data storage section 43.

When the command to execute the measurement is issued by the user, the measurement executer 53 performs a chromatographic analysis of a sample by executing the batch file saved in the measurement-data storage section 43 so as to acquire chromatogram data and save the data in the measurement-data storage section 43. As with the reference waveform data, this chromatogram data is one-dimensional data in which output signals from the detector, for example, are arranged in time series. This data corresponds to the analysis-target data in the present invention. Although the present example assumes that a chromatogram is newly acquired by a measurement of a sample performed by the measurement executer 53, the acquisition of chromatogram data may be achieved in a different way, e.g., by retrieving a set of previously acquired chromatogram data.

After the chromatogram data has been acquired by performing a measurement of a sample or retrieving already acquired data (Step 11), the user issues a command to analyze the chromatogram data. Then, the window setter 54 creates a chromatogram from the read data and displays it on the screen of the display unit 7 (Step 12). Additionally, based on the sampling rate, type of detector and entire measurement period described in the measurement conditions, the window setter 54 determines the values of the widths of the corresponding windows and shows those values on the display unit 7. The width of the first window is the sampling rate multiplied by 1,024, that of the second window is a value related to the type of detector, and that of the third window is the entire measurement period. The user checks the values of those windows shown on the display unit 7 and performs a predetermined input operation to confirm those values (Step 13).

After the widths of the windows have been determined by the user, the first-index output processor 55 reads 1,024 points of measurement data elements from the beginning of the chromatogram data and inputs them into the first trained model. For each of the inputted chromatogram data elements, the first trained model outputs one of the labels of “baseline”, “single (isolated peak)”, “complete separation peak”, “vertical partitioning peak”, “peak-beginning point”, “peak-ending point”, “single peak on a tailing portion”, “vertical partitioning peak on a tailing portion”, and “washing section” (Step S14). The steps of shifting the first window so that the neighboring windows overlap each other and inputting 1,024 points of data elements to obtain an output of the label for each data element are repeatedly performed throughout the entire measurement range. Consequently, one or more labels are outputted for each of all measurement data elements (a plurality of labels are outputted for measurement data located within the overlapping portion of the windows).

The second-index output processor 56 applies the second window to the chromatogram and performs the process of reducing the number of data elements included within the second window to 1,024 points. Specifically, the process may include totaling or averaging a plurality of measurement data elements or thinning the measurement data elements, as in the case where the second window was applied to the teaching data. Then, the second-index output processor 56 reads 1,024 measurement data elements from the beginning of the chromatogram data and inputs them into the second trained model. For each of the inputted measurement data elements, the second trained model outputs one of the labels of “peak-beginning point”, “peak-ending point”, “single peak”, “tailing processing peak”, “complete separation peak”, “vertical partitioning peak” and “non-peak portion”. The steps of shifting the second window so that the neighboring windows overlap each other and inputting 1,024 points of data elements to obtain an output of the label for each data element are repeatedly performed throughout the entire measurement range. Consequently, one or more labels are outputted for each of all measurement data elements (Step 15). Once again, a plurality of labels are outputted for measurement data elements located within the overlapping portion of the windows.

The third-index output processor 57 performs the process of reducing all measurement points to 1,024 points. Specifically, the process may include totaling or averaging a plurality of measurement data elements or thinning the measurement data elements, as in the case where the third window was applied to the teaching data. Then, the third-index output processor 57 inputs the 1,024 points of measurement data elements into the third trained model. For each of the inputted measurement data elements, the third trained model outputs one of the labels of “baseline”, “single (isolated peak)”, “complete separation peak”, “vertical partitioning peak”, “peak-beginning point”, “peak-ending point”, “single peak on a tailing portion”, “vertical partitioning peak on a tailing portion”, and “washing section”. Thus, one label is outputted for each of all measurement data elements (Step 16).

After the process in which all windows are applied to the target chromatogram data has been completed, the peak portion estimator 58 determines the label of each measurement data element. If there is a measurement data element (measurement point) for which a plurality of labels have been outputted, the peak portion estimator 58 combines those labels. Based on the labels of the measurement data elements, the peak portion estimator 58 estimates the peak portion (Step 17). If there is a measurement data element for which different labels have been outputted, the peak portion estimator 58 selects one label for that measurement data element (measurement point) based on a previously determined order of priority. Specifically, for example, if one label representing a peak portion and another label representing a non-peak portion are outputted for the same data element, a priority is given to the peak portion. As for the single peak and the overlap peak (tailing processing peak, complete separation peak, or vertical partitioning peak), a priority is given to the overlap peak. These rules prevent the situation in which the presence of a peak is overlooked, or the situation in which an overlap peak that requires peak separation is incorrectly estimated as a single peak.

As regards the label of the washing section, it is preferable to determine that the section in question is the washing section only when the following conditions are satisfied: the period of time in question consists of a continuous series of measurement data elements for which the label of the washing section has been outputted; and the length of that continuous period of time is equal to or longer than a previously determined period of time, or its proportion to the entire range of time of the chromatogram being analyzed is equal to or greater than a previously determined value. It is practically impossible to wash a column within a period of time that corresponds to one or a few measurement data elements. Therefore, even when the trained model has erroneously outputted the label of the washing section, the error can be corrected by the previously described processing. It should be noted that the column-washing period is previously specified as a measurement condition, and its length as well as its proportion to the entire measurement period can be read from the measurement conditions.

The previously described conditions can also be applied in the case of using a trained model which outputs the label of the no-elution section (which identifies the period of time until a component having the shortest retention time among the components in the sample exits from the column, i.e., the period of time during which there is no need to detect peaks). That is to say, it is preferable to determine that the period of time in question is the no-elution section only when the following conditions are satisfied: the section in question consists of a continuous series of measurement data elements for which the label of the no-elution section has been outputted; and the length of that continuous period of time is equal to or longer than a predetermined period of time, or its proportion to the entire range of time of the chromatogram being analyzed is equal to or greater than a predetermined value. The washing section and the no-elution section may be collectively referred to as a “no-detection section”.

Ultimately, the analysis result outputter 59 displays, on the display unit 7, the analysis result (the labels given to the respective measurement data elements) along with the chromatogram being analyzed (Step 18). This allows the user to visually recognize a peak which is considered to be present in the chromatogram being analyzed.

In the case of analyzing a known kind of target component contained in a sample (“target analysis”), a mass analyzer is used as the detector, for example, and an SIM or MRM measurement in which an ion generated from the target component is selected as the target ion is performed to create an extracted ion chromatogram. In the target analysis, the peak detection only needs to be performed on the waveform within a limited range of time (e.g., 1.5 minutes long) corresponding to the retention time of the target component within the entire measurement period of the chromatograph (for example, see Non Patent Literature 3). Since the SIM or MRM measurement has a high degree of selectivity for the target component, a narrow, sharp peak can be obtained. The waveform-analyzing technique described in Patent Literature 1 was developed on the assumption of detecting a peak from such a waveform.

On the other hand, in the case of an exhaustive analysis of unknown components contained in a sample (“non-target analysis”), or in the case of using a PDA detector or UV detector as the detector, the component selectivity is lower than in the case of a target analysis using a mass analyzer, and a plurality of peaks are likely to overlap each other on the chromatogram.

Furthermore, when a gradient analysis is performed in a liquid chromatograph, or when a temperature-programmed analysis is performed in a gas chromatograph, a drift of the baseline is likely to occur. When a plurality of peaks overlapping each other (overlap peak) are present on a chromatogram, those peaks need to be separated by one of the conventionally known peak separation techniques including the tailing processing, complete separation and vertical partitioning, and the most suitable technique for separating the peaks depends on the shape of the baseline. Since the shape of the baseline varies depending on the configuration of the analyzer and the measurement conditions, there are cases in which it is difficult to correctly detect peaks by conventional trained models.

In contrast, in the present embodiment, as described earlier, the reference waveform data includes various types of chromatograms: a chromatogram acquired by a gradient analysis, with the baseline increasing (or decreasing) throughout the entire measurement period; a chromatogram acquired by a continuous measurement of a plurality of samples, with a column-washing period provided in the middle of the continuous measurement; and a chromatogram having an overlap peak consisting of a peak having a leading or tailing portion on which another peak is superposed (an overlap peak to which the tailing processing is related) and/or an overlap peak consisting of a plurality of peaks whose base portions overlap each other (an overlap peak to which either the complete separation or the vertical partitioning is related), with the labels of the tailing processing subdivided into the “single peak on a tailing portion”, “vertical partitioning peak on a tailing portion”, “peak on a tailing portion” and “peak on a leading portion”. Therefore, a trained model which can discriminate between various forms of the baseline as well as between various shapes of overlap peaks will be constructed. The use of such a trained model for the peak detection from chromatogram data to be analyzed enables the correct detection of the peak and the correct estimation of the separation method to be used for separating an overlap peak even when a drift of the baseline is present and even when an overlap peak is present in addition to the drift.

In the present embodiment, the first, second and third trained models are constructed by three modes of machine learning which respectively use three windows having different widths. This allows for the use of the first trained model which can correctly detect narrow peaks and the second trained model which can correctly detect broad peaks. The third trained model which uses a single window covering the entire measurement range can correctly detect the fluctuating baseline throughout the entire measurement time range and correctly discriminate between a fluctuation of the baseline and a peak.

In addition, it is possible to prepare measurement data representing a pseudo broad peak by expanding an extremely small peak in the temporal direction (as well as the intensity direction) and use that data for the machine learning of the learning model. However, in that case, the data used for the machine learning will include not only the peak but also the noise level expanded in the temporal direction. Since none of the noise components detected in actual measurements is temporally expanded in this manner, the aforementioned type of machine learning will create a trained model that has learned waveforms that will never occur in actual measurement data. A trained model created in this manner cannot correctly discriminate between non-peak portions (noise components) and peak portions in the analysis-target data acquired by actual measurements.

Hereinafter described is an example in which the present inventor analyzed an actual chromatogram by using the waveform-analyzing device and the waveform-analyzing method according to the previously described embodiment. In the present example, according to the procedure as described in the previous embodiment, a trained model was constructed which was configured to output a label (index) showing a numerical value of 0 (baseline), 1 (single, isolated peak), 2 (overlap peak which should be vertically partitioned), 3 (peak-beginning point), 4 (peak-ending point), 5 (single peak on a tailing portion), 6 (vertical partitioning peak on a tailing portion) or 7 (washing section). From the data of a chromatogram acquired by continuously performing a gradient analysis for a plurality of samples, a portion of the chromatogram data corresponding to the measurement of one sample was extracted as an analysis-target data and fed into the trained model to obtain one of the aforementioned labels as an output for each of the measurement data elements constituting the analysis-target data.

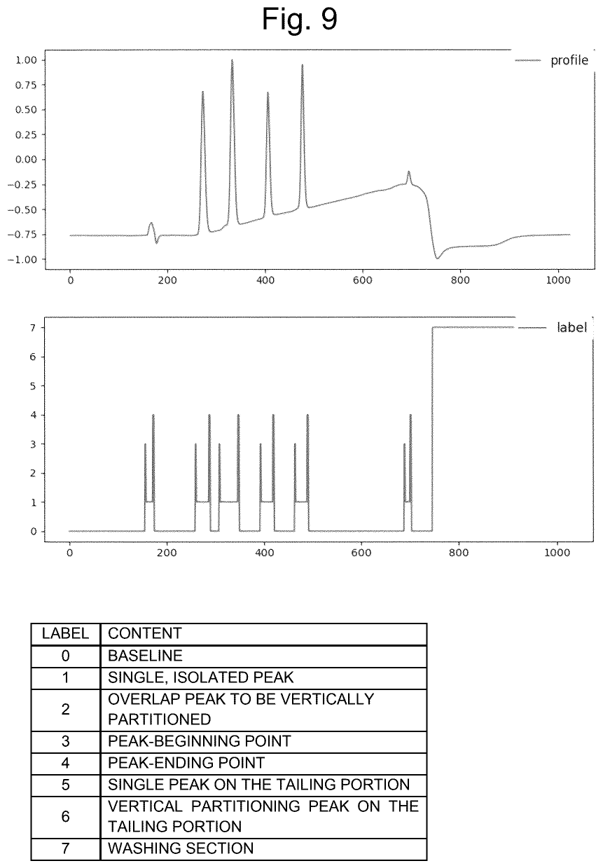

FIG. 9 shows the analysis result. The upper section of FIG. 9 is the waveform of the chromatogram created from the analysis-target data (the same chromatogram as shown in FIG. 2). The middle section of FIG. 9 is a chart in which the label outputted from the trained model for each measurement data element is plotted. The lower section of FIG. 9 is a description of the labels. As can be understood from the comparison between the waveform of the chromatogram in the upper section of FIG. 9 and the output labels in the middle section of FIG. 9, despite the significant fluctuation of the baseline due to the gradient analysis and the column washing as well as the presence of a number of peaks of various sizes on the drifting baseline, the peaks have been correctly detected from the waveform by the waveform-analyzing device and the waveform-analyzing method according to the present embodiment. Since no overlap peak was present on the chromatogram used in this example, the present inventor tested another chromatogram and obtained outputs of the label as in the previous example. The test result confirmed that the detection of an overlap peak as well as the estimation of the suitable method for separating the peak were correctly achieved.

The previous embodiment is a mere example and can be appropriately changed or modified without departing from the spirit of the present invention.

In the previous embodiment, three trained models were created by machine learning in which three windows with different widths were applied. The number of kinds of windows or that of the trained models may be one or two as well as four or more.

Although the analysis-target data in the previous embodiment was chromatogram data acquired by a measurement using a liquid chromatograph, the waveform-analyzing method and waveform-analyzing device according to the present invention can be used for analyzing waveforms formed by various kinds of data. For example, an analysis similar to the previously described one can be performed on a waveform formed by chromatogram data acquired by a measurement using a gas chromatograph, or a waveform formed by measurement data which is not chromatogram data. Furthermore, an analysis similar to the previously described one can also be performed, for example, on an optical spectrum acquired by a measurement using a spectrophotometer (a waveform representing a change in detection intensity with respect to a wavelength or wavenumber axis), or mass spectrum acquired by a measurement using a mass spectrometer.

In the previous embodiment, the second trained model was constructed by performing machine learning in which the second window having a width previously related to the type of detector was applied to the training data. Another possibility is to create a plurality of trained models for one detector by applying, to the training data, a plurality of windows having different widths, and to save those models in the trained-model storage section 44, with each model associated with the information concerning the width of the window (and the type of detector). In this case, a chromatogram created from the chromatogram data to be analyzed is shown on the display unit 7, on which the user can check the shape of the chromatogram and change the width of the second window. When the width of the second window has been changed by the user, the second-index output processor 56 retrieves, from the trained-model storage section 44, a second trained model corresponding to the width of the second window after the change, and outputs a label for each measurement data element in the previously described manner. Additionally, when it is evident that there is no drift or similar fluctuation of the baseline over the entire measurement period in the chromatogram being analyzed, the estimation of the peak portion may be performed without using the third window.

The previously described configuration may be altered to allow the user to enter an expected value of the peak width instead of changing the width of the window. In this case, the value obtained by multiplying the entered peak width by a previously determined constant (e.g., 1.5 or 2) can be used as the width of the second window for performing the processing in the previously described manner.

In the previous embodiment, U-Net was used for all of the first, second and third trained models. It is also possible to use a different type of model for each trained model. For those trained models, neural networks can be suitably used, in which various kinds of architectures are included, such as an architecture which performs semantic segmentation, one which performs object detection (SSD), one which uses a regression model, a recurrent neural network (RNN), and a transformer. By appropriately using these types of architecture for constructing the trained models, the detection accuracy of the peak portion can be improved.

In the previous embodiment, one label was outputted for each measurement data element and the analysis result was shown on the display unit 7. Depending on the architecture which constitutes the model, the trained model may possibly output a plurality of labels and their respective degrees of certainty as the inferred result for one measurement data element. The U-Net described in the previous embodiment is also this type of architecture. Only the label having the highest degree of certainty was outputted in the previous embodiment. However, when this type of trained model is used, other labels with their respective degrees of certainty may also be shown on the display unit 7 in addition to the label having the highest degree of certainty. By this method, if the label considered to have the highest degree of certainty has been judged to be incorrect, the user can change to the label having the second highest degree of certainty to more correctly estimate the peak. Another possibility is to display, on the display unit 7, one or more labels whose degrees of certainty are equal to or higher than a previously determined value. In this case, the data analysis can be efficiently carried out since the user only needs to check labels having high degrees of certainty.

### Modes

It is evident to a person skilled in the art that the previously described illustrative embodiment is a specific example of the following modes of the present invention.

### Clause 1

One mode of the present invention is a waveform-analyzing method for analyzing a waveform formed by analysis-target data which is a set of data acquired by a measurement of a sample using an analyzer, the waveform-analyzing method including:
a trained-model construction step for constructing a trained model by machine learning in which a plurality of sets of reference waveform data which are sets of data each of which forms one of a plurality of reference waveforms are used as teaching data, where each of the reference waveforms has a different shape of the baseline, has a known position of a peak portion including an overlap peak, and is related to a technique selected from the group consisting of tailing processing, complete separation and vertical partitioning as a technique for separating the overlap peak, and the trained model is configured to receive an input of measurement data and output an index for each of data elements constituting the measurement data, where the index represents a single-peak portion, an overlap-peak portion or a non-peak portion and is related to a technique selected from the group consisting of tailing processing, complete separation and vertical partitioning as the technique to be used for separating the overlap peak concerned; and
an index output step for inputting the analysis-target data into the trained model and obtaining, from the trained model, an output of the index for each of a plurality of analysis-target-data elements constituting the analysis-target data, where the index represents a single-peak portion, an overlap-peak portion or a non-peak portion and is related to a technique selected from the group consisting of tailing processing, complete separation and vertical partitioning as the technique to be used for separating the overlap peak concerned.

### Clause 2

Another mode of the present invention is a waveform-analyzing device configured to analyze a waveform formed by analysis-target data which is a set of data acquired by a measurement of a sample using an analyzer, the waveform-analyzing device including:
a trained-model storage section in which a trained model is stored, the trained model constructed by machine learning in which a plurality of sets of reference waveform data which are sets of data each of which forms one of a plurality of reference waveforms are used as teaching data, where each of the reference waveforms has a different shape of the baseline, has a known position of a peak portion including an overlap peak, and is related to a technique selected from the group consisting of tailing processing, complete separation and vertical partitioning as a technique for separating the overlap peak, and the trained model is configured to receive an input of measurement data and output an index for each of data elements constituting the measurement data, where the index represents a single-peak portion, an overlap-peak portion or a non-peak portion and is related to a technique selected from the group consisting of tailing processing, complete separation and vertical partitioning as the technique to be used for separating the overlap peak concerned; and a
n index outputter configured to input the analysis-target data into the trained model and obtain, from the trained model, an output of the index for each of a plurality of analysis-target-data elements constituting the analysis-target data, where the index represents a single-peak portion, an overlap-peak portion or a non-peak portion and is related to a technique selected from the group consisting of tailing processing, complete separation and vertical partitioning as the technique to be used for separating the overlap peak concerned.

In the waveform-analyzing method according to Clause 1 and the waveform-analyzing device according to Clause 2, when a trained model is constructed by machine learning, a plurality of sets of reference waveform data are used as teaching data for performing the machine learning, where the plurality of sets of reference waveform data are sets of data each of which forms one of a plurality of reference waveforms, where each of the reference waveforms has a different shape of the baseline, has a known position of a peak portion including an overlap peak which is a plurality of peaks overlapping each other, and is related to a technique selected from the group consisting of tailing processing, complete separation and vertical partitioning as a technique for separating the overlap peak. Therefore, a trained model is constructed which takes into account the shape of the baseline in estimating the peak portion as well as in estimating the peak-separation technique suitable for an overlap peak. According to the waveform-analyzing method according to Clause 1 and the waveform-analyzing device according to Clause 2, when analysis-target data is fed into the trained model, the model correctly estimates the peak portion by taking into account the shape of the baseline which appears in a specific form depending on the type of detector and the measurement conditions. The model also outputs an index which represents a peak separation technique suitable for separating the overlap peak. Therefore, the peaks can be correctly detected from the chromatogram regardless of the configuration of the device and the measurement conditions.

### Clause 3

In the waveform-analyzing device according to Clause 3, which is a waveform-analyzing device according to Clause 2, the tailing processing further includes a single peak on a tailing portion and a vertical partitioning peak on a tailing portion.

In the waveform-analyzing device according to Clause 3, more subdivided techniques can be used as the technique for separating an overlap peak consisting of a tailing peak on which another peak is emergent. Therefore, the overlap peak can be more appropriately separated.

### Clause 4

In the waveform-analyzing device according to Clause 4, which is a waveform-analyzing device according to Clause 2 or 3, the reference waveforms include a no-detection section within which there is no need to detect peaks, and the trained model is further configured to output an index representing a no-detection section.

### Clause 5

In the waveform-analyzing device according to Clause 5, which is a waveform-analyzing device according to Clause 4, the no-detection section includes a chromatogram within a period of time until a component having the shortest retention time among the components contained in a sample exits from a column and/or a chromatogram within a period of time for washing a column.

In the waveform-analyzing device according to Clause 4, no-detection sections in the analysis-target data are estimated by using a trained model which has learned no-detection sections in the reference waveforms by machine learning. Therefore, it is possible to exclude no-detection sections from the analysis-target data and efficiently estimate peaks. As described in Clause 5, examples of the no-detection section include a chromatogram within a period of time until a component having the shortest retention time among the components contained in a sample exits from a column, and a chromatogram within a period of time for washing a column in a measurement in which a gradient analysis of a plurality of samples is continuously performed.

### Clause 6

In the waveform-analyzing device according to Clause 6, which is a waveform-analyzing device according to Clause 4 or 5, the index outputter is configured to determine that a section corresponding to a period of time during which the no-detection section continues is a no-detection section when that period of time is longer than a previously determined period of time, or when the proportion of that period of time to a period of time during which the analysis-target data was acquired exceeds a previously determined value.

In the waveform-analyzing device according to Clause 6, even when the trained model has erroneously outputted the index of the no-detection section for partial measurement data corresponding to an extremely short period of time, that error can be corrected.

### Clause 7

In the waveform-analyzing device according to Clause 7, which is a waveform-analyzing device according to one of Clauses 2-6, the trained model is constituted by an architecture which outputs, for one measurement data element, a plurality of indices and the degree of certainty of each index, and the index outputter is configured to obtain, for each of the analysis-target-data elements, an output of each of a plurality of indices and the degree of certainty of each index from the trained model.

When a waveform having a complex shape is fed into the trained model, a plurality of indices whose degrees of certainty are comparable to each other may be outputted for one data element. In such a case, the waveform-analyzing device according to Clause 7 allows the user to check the plurality of indices whose degrees of certainty are comparable to each other and select an appropriate index.

### Clause 8

In the waveform-analyzing device according to Clause 8, which is a waveform-analyzing device according to Clause 7, the trained model is configured to output, for each of the analysis-target-data elements, an index whose degree of certainty is equal to or higher than a previously determined value.

The waveform-analyzing device according to Clause 8 allows the user to efficiently perform data analysis since the user only needs to check labels having high degrees of certainty.

### REFERENCE SIGNS LIST

1 . . . Liquid Chromatograph System
10 . . . Liquid Chromatograph Unit
11 . . . Mobile Phase Container
12 . . . Liquid Supply Pump
13 . . . Injector
14 . . . Column
15 . . . Detector
16 . . . Autosampler
40 . . . Control-and-Processing Unit
41 . . . Storage Unit
42 . . . Reference-Waveform-Data Storage Section
43 . . . Measurement-Data Storage Section
44 . . . Trained-Model Storage Section
51 . . . Trained Model Creator
52 . . . Measurement Condition Setter
53 . . . Measurement Executer
54 . . . Window Setter
55 . . . First-Index Output Processor
56 . . . Second-Index Output Processor
57 . . . Third-Index Output Processor
58 . . . Peak Portion Estimator
59 . . . Analysis Result Outputter
6 . . . Input Unit
7 . . . Display Unit

1. A waveform-analyzing method for analyzing a waveform formed by analysis-target data which is a set of data acquired by a measurement of a sample using an analyzer, the waveform-analyzing method comprising:
a trained-model construction step for constructing a trained model by machine learning in which a plurality of sets of reference waveform data which are sets of data each of which forms one of a plurality of reference waveforms are used as teaching data, where each of the reference waveforms has a different shape of a baseline, has a known position of a peak portion including an overlap peak, and is related to a technique selected from a group consisting of tailing processing, complete separation and vertical partitioning as a technique for separating the overlap peak, and the trained model is configured to receive an input of measurement data and output an index for each of data elements constituting the measurement data, where the index represents a single-peak portion, an overlap-peak portion or a non-peak portion and is related to a technique selected from the group consisting of tailing processing, complete separation and vertical partitioning as the technique to be used for separating the overlap peak concerned; and
an index output step for inputting the analysis-target data into the trained model and obtaining, from the trained model, an output of the index for each of a plurality of analysis-target-data elements constituting the analysis-target data, where the index represents a single-peak portion, an overlap-peak portion or a non-peak portion and is related to a technique selected from the group consisting of tailing processing, complete separation and vertical partitioning as the technique to be used for separating the overlap peak concerned.

2. A waveform-analyzing device configured to analyze a waveform formed by analysis-target data which is a set of data acquired by a measurement of a sample using an analyzer, the waveform-analyzing device comprising:
a trained-model storage section in which a trained model is stored, the trained model constructed by machine learning in which a plurality of sets of reference waveform data which are sets of data each of which forms one of a plurality of reference waveforms are used as teaching data, where each of the reference waveforms has a different shape of a baseline, has a known position of a peak portion including an overlap peak, and is related to a technique selected from a group consisting of tailing processing, complete separation and vertical partitioning as a technique for separating the overlap peak, and the trained model is configured to receive an input of measurement data and output an index for each of data elements constituting the measurement data, where the index represents a single-peak portion, an overlap-peak portion or a non-peak portion and is related to a technique selected from the group consisting of tailing processing, complete separation and vertical partitioning as the technique to be used for separating the overlap peak concerned; and
an index outputter configured to input the analysis-target data into the trained model and obtain, from the trained model, an output of the index for each of a plurality of analysis-target-data elements constituting the analysis-target data, where the index represents a single-peak portion, an overlap-peak portion or a non-peak portion and is related to a technique selected from the group consisting of tailing processing, complete separation and vertical partitioning as the technique to be used for separating the overlap peak concerned.

3. The waveform-analyzing device according to claim 2, wherein the tailing processing further includes a single peak on a tailing portion and a vertical partitioning peak on a tailing portion.

4. The waveform-analyzing device according to claim 2, wherein:
the reference waveforms include a no-detection section within which there is no need to detect peaks; and
the trained model is further configured to output an index representing a no-detection section.

5. The waveform-analyzing device according to claim 4, wherein the no-detection section includes a chromatogram within a period of time until a component having the shortest retention time among the components contained in a sample exits from a column and/or a chromatogram within a period of time for washing a column.

6. The waveform-analyzing device according to claim 4, wherein the index outputter is configured to determine that a section corresponding to a period of time during which the no-detection section continues is a no-detection section when that period of time is longer than a previously determined period of time, or when the proportion of that period of time to a period of time during which the analysis-target data was acquired exceeds a previously determined value.

7. The waveform-analyzing device according to claim 2, wherein:
the trained model is constituted by an architecture which outputs, for one measurement data element, a plurality of indices and a degree of certainty of each index; and
the index outputter is configured to obtain, for each of the analysis-target-data elements, an output of each of a plurality of indices and the degree of certainty of each index from the trained model.

8. The waveform-analyzing device according to claim 7, wherein the trained model is configured to output, for each of the analysis-target-data elements, an index whose degree of certainty is equal to or higher than a previously determined value.
